(19) United States
(12) Patent Application Publication
(10) Pub. No.: US 2018/0325053 A1
(43) Pub. Date: Nov. 15, 2018

(54) Growing Tray and Cap for Rotating Hydroponic Gardening

(71) Applicant: Roto-gro Inc., Caledon (CA)

(72) Inventor: Jim Gallant, Caledon (US)

(21) Appl. No.: 16/036,189

(22) Filed: Jul. 16, 2018

Related U.S. Application Data
(63) Continuation-in-part of application No. 14/287,666, filed on May 27, 2014, now abandoned.

(51) Int. Cl. A01G 31/02; A01G 9/04

(52) U.S. Cl. CPC A01G 31/02; A01G 9/047

(57) ABSTRACT

This invention relates to a growing tray and growing tray system for a rotating hydroponic garden. The growing tray is shaped to hold a standard cube of hydroponic growing media with or without a basket with a cap to cover the top opening in the tray between the plants. The growing tray may include an indentation at the bottom of the growing tray to provide room for root growth expansion. The cap may additionally include a flap for covering the space between growing trays in a rotating hydroponic garden.

### CROSS REFERENCE TO RELATED APPLICATIONS

This application is a continuation-in-part of U.S. patent application Ser. No. 14/287,666 filed May 27, 2014, the disclosure of which is hereby incorporated in its entirety by reference.

### BACKGROUND OF THE INVENTION

### Field of Invention

This invention relates to hydroponic gardening and more particularly to a growing tray system for a rotating hydroponic garden.

### Background of the Invention

Indoor gardening systems are designed to enhance growing through controlling the light, temperature, nutrients and water conditions for plants. Plants can be grown indoors in dirt media or hydroponically in solution or in solid media, namely, sand, gravel or rockwool. Growing trays of plants in either dirt or hydroponic medium are laid out on tables, with plants spaced in the dirt or hydroponic media to allow growth. Plants in solution have different growing parameters. An example of a hydroponic growing system is found in U.S. Pat. No. 8,667,734 entitled Hydroponic Plant Container with Highly Oxygenated Nutrient Solution Using Continuous Air Infection and Continuous Coriolis Effect Mixing and an example of a hydroponic growing system is found in U.S. patent application Ser. No. 13/352,159 (publication #20130180172) entitled Rotating Plant Containing Module with Self-Contained Irrigation System.

In hydroponic gardening it is possible to grow individual plants in individual cubes of hydroponic media and there are standard sizes of such cubes currently widely used. Plants are grown most often in 4 inch×2½ inch cubes of rockwool or baskets of gravel, typically lava rocks. A growing cube of rockwool is self-contained, wrapped or in a container, but lava rocks are in a basket to hold them together. In either case, there is a hole in the top of the cubes or made in the lava rocks, in which a seedling which is itself in its own growing media may be inserted. For example, seeds are typically sprouted in one inch cubes of rockwool hydroponic media. Seedlings in the 1 inch cubes are dropped into the 1 inch cubic space in the top of a growing cube of hydroponic media, for example rockwool or into a hole made in the lava rocks in a basket.

Given that trays of plants in either dirt or hydroponic media on tables take up a lot of square space just like fields of crops, but are more costly in that the trays are indoors, various space saving measures have been developed to stack or to rotate growing trays. These systems have been adapted such that they still adequately deliver light and water to the plants.

For example, US Pat. No. 7,401,437 and Canadian patents 2,421,389, 2,431,523 and 2,460,465, entitled Rotary Plant Growing Apparatus, describe an adaptation of a rotary drum growing system. Canadian patents 2,401,737 and 2,396,317 describe a further adaptation of a rotary drum growing system, as does Canadian patent 2,343,254. These and other rotary drum growing systems allow plants in rows of growing trays to rotate around a light source.

In a rotating drum hydroponic growing system, plants in rockwool growing cubes are slid into either end of a growing tray. Plants are spaced along the tray to allow for adequate growth of the particular plant. The growing trays are placed in the rotating drum.

Growing cubes which are gravel baskets are problematic in a rotating system since the gravel can fall out the top when rotating upside down.

In between the cubes there are open empty spaces which space varies depending on the desired distance between the plants. A healthy and large root system is very important for a plant in order to absorb water and nutrients. However, in the rotating hydroponic system plant roots are inhibited from growing in the empty spaces between the growing cubes due to exposure to the light.

A growing tray for a rotating drum hydroponic system for various types of hydroponic media which doesn't inhibit root growth is needed.

### SUMMARY OF INVENTION

In an embodiment of the present invention, there is a growing tray for growing plants, comprising an open ended trough with a bottom, sides and a top comprising an open channel, said channel may be bordered by attachment means for attaching a cap with corresponding attachment means.

The cap is capable of partially, non-contiguously or fully covering said channel. The growing tray may additionally comprise an indentation into the bottom of the trough.

In a further embodiment, there is a growing tray system comprising a growing tray and a cap, said growing tray comprising an open ended trough with a bottom, sides and a top comprising an open channel, and said cap capable of covering the open channel.

The cap of the growing tray system may additionally comprise two longitudinal grooves and the channel is bordered by two longitudinal tongues whereby when the cap is covering the open channel each tongue is engaged with an adjacent groove. The growing tray system may also additionally comprise an indentation into the bottom of the trough.

In an embodiment of the present invention, there is provided a light resistant cap capable of covering the top of a growing tray for holding plants, said cap comprising a material capable of being cut to provide gaps through which the plants can grow. In this cap the gaps can be holes or alternatively, the gaps can make the cap non-contiguous. In a further embodiment, the cap and growing tray can additionally comprise attachment means for attachment of the cap to the growing tray.

In an embodiment of the present invention, there is provided a basket for holding hydroponic media for use in the growing tray and a basket for use in the growing tray system.

In a further embodiment of the present invention there is a cap for a plant growing tray for a rotatable hydroponic garden, said cap comprising a tray covering portion for covering the tray and a flap portion, wherein the tray covering portion is adapted to removably secure to the growing tray, and said flap is adapted so that when said growing plant trays covered with said caps are placed adjacent to one another in a rotatable hydroponic garden the space between the trays is covered by the flaps. The flap may additionally comprise air holes. The tray covering portion may additionally comprise grow holes for plants to grow through.

In yet a further embodiment of the present invention there is a plant growing tray and cap for a rotatable hydroponic garden, said plant growing tray comprising a trough having a first end and a second end, at least one of the first end and the second end being open, a bottom, sides, and a top defining a channel exposing the interior of the trough, and said sides adapted with receiving means for removably securing the cap to the plant growing tray, and said cap comprising a tray covering portion and a flap portion, wherein the tray covering portion is adapted with securing means to removably secure the tray covering portion to the growing tray, and said flap is adapted so that when plant growing trays covered with said caps are placed adjacent to one another in a rotatable hydroponic garden the space between the trays is covered by the flaps. The flap may additionally comprise air holes. The tray covering portion may additionally comprise grow holes for plants to grow through.

The receiving means may comprise gripping channels running along the sides of the plant growing tray and the securing means may comprise straight tongues extending substantially perpendicularly on each side of the tray covering portion, wherein the cap is removably secured to the plant growing tray when the straight tongues are inserted into the gripping channels. The securing means may additionally comprise at least one lip on the tray covering portion parallel to one or both straight tongues such that when the cap is removably secured to the plant growing tray the lip grips the outside of the gripping channel.

The plant growing tray may additionally provide a space for roots of a plant to expand by providing an interior surface of the bottom comprising a raised portion having a substantially flat shelf for receiving a plant.

### DESCRIPTION OF DRAWINGS

These and other aspects of the present invention will be apparent from the brief description of the drawings and the following detailed description in which:

FIG. 1 is a perspective view of a growing tray of an embodiment of the present invention.

FIG. 2 is perspective view of a cap of an embodiment of the present invention.

FIG. 3 is an end view of the cap of FIG. 2.

FIG. 4 is a perspective view of a growing tray and cap of an embodiment of the present invention.

FIG. 5 is a perspective view of a basket of an embodiment of the present invention

FIG. 6 is an end view of the growing tray and cap of FIG. 4 with the basket of FIG. 5.

FIG. 7 is a perspective view of the growing tray, cap and basket of FIG. 6 with plants.

FIG. 8 is an end view of a growing tray and a cap of a second embodiment of the present invention.

FIG. 9 is a perspective view of a cap of a third embodiment of the present invention.

FIG. 10 is a perspective view of a growing tray of a third embodiment of the present invention.

FIG. 11 is a perspective view of the growing tray of FIG. 10 with the cap of FIG. 9 with plants.

FIG. 12 is a cutaway side view of multiple units of the growing tray and cap with plants of FIG. 11 in a rotating hydroponic garden.

### DETAILED DESCRIPTION OF INVENTION

In an embodiment of the present invention there is provided a growing tray for growing plants, comprising an open ended trough with a bottom, sides and a top comprising an open channel. The channel may be bordered by attachment means for attaching a cap with corresponding attachment means. The cap can cover said open channel in full, non-contiguously or in part. In an embodiment of the present invention there is provided a growing tray system comprising the growing tray and the cap. In a further embodiment of the invention the cap additionally comprises two longitudinal grooves and the channel is bordered by two longitudinal tongues whereby when the cap is covering the open channel each tongue is engaged with an adjacent groove.

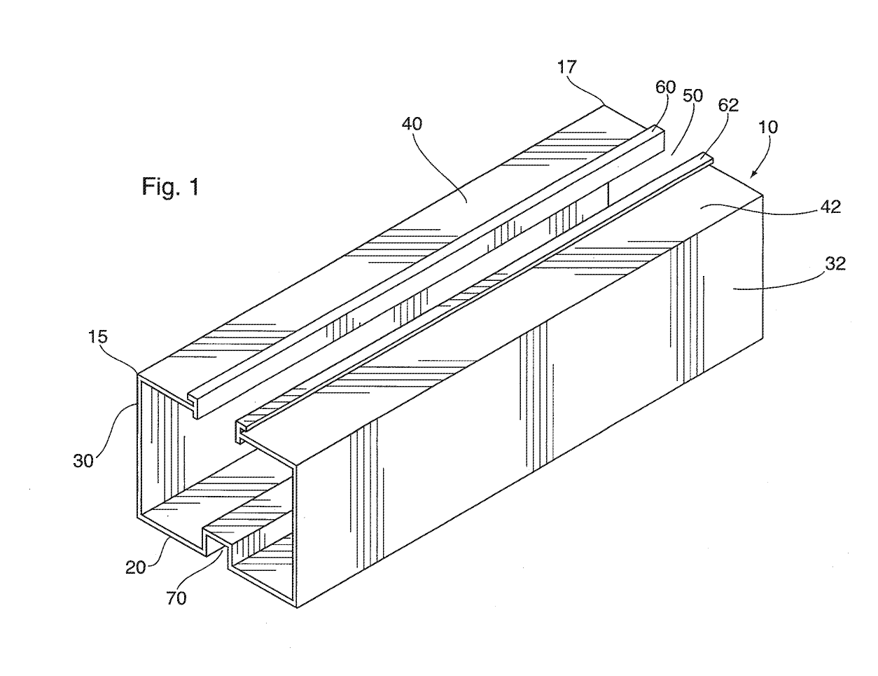

With reference to the drawings, the growing tray of an embodiment of the present invention is shown in FIG. 1 in which the growing tray 10 is an open ended trough comprised of a bottom 20, first side 30 and second side 32, first top 40 and second top 42 separated by a channel 50. Bordering the channel 50 from first end 15 to second end 17 is a first tongue means 60 and a second tongue means 62. While this growing tray could be used in any system, it is capable of use in a rotating drum hydroponic growing system. In a rotating drum hydroponic growing system, a drum rotates around a light and rows of growing trays line the interior of the drum. Plants in hydroponic media are slid into the trays with the plants facing the light. As such, as the drum rotates, the plants rotate and are always facing the light, but are sometimes upside down. Given the standard size of the growing cubes, the channel 50 is narrow enough to hold the growing cube in so that it doesn't fall out when rotating and large enough for the plant to grow through.

In a further embodiment of the present invention the bottom 20 additionally comprises an indentation 70. If the indentation 70 is not present in the growing tray 10, the bottom 20 is substantially flat. The indentation may be any shape that functions to create space on either side of the indentation 70 in which roots from a plant can expand into.

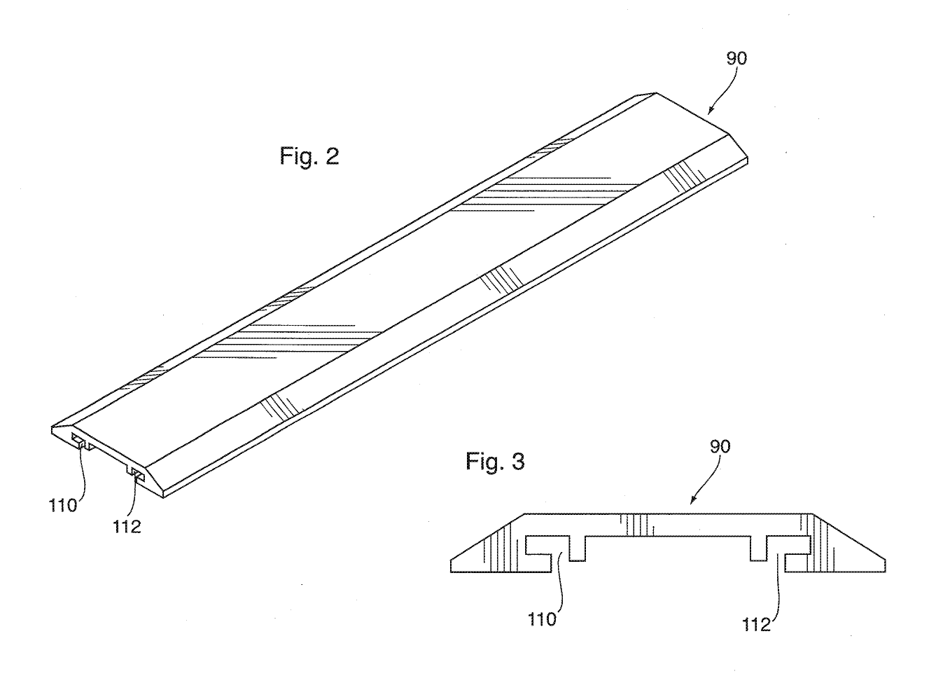

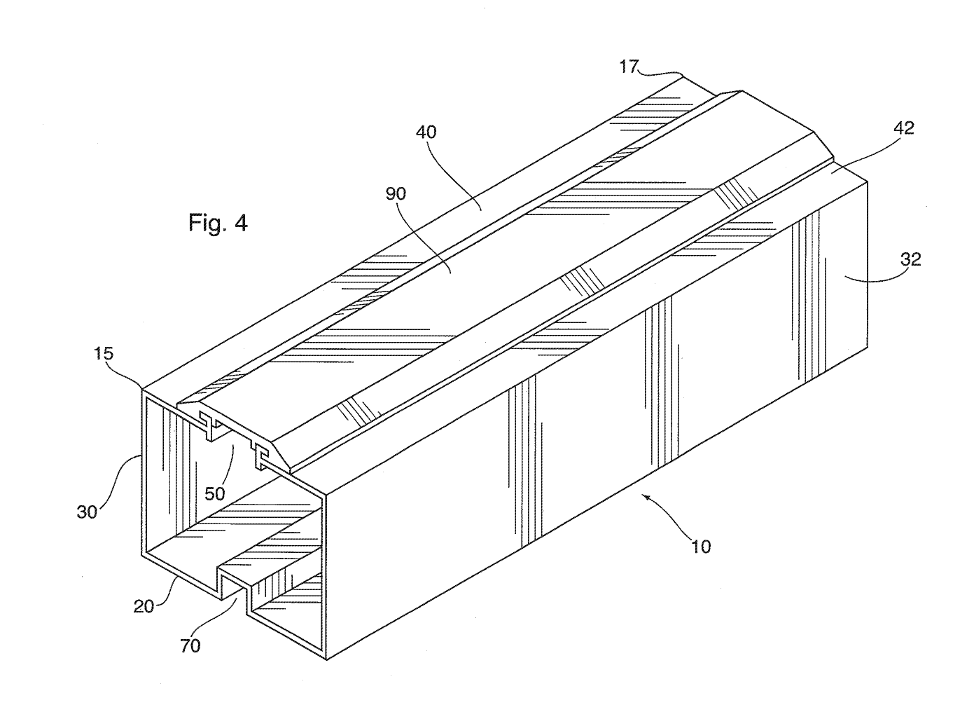

FIGS. 2 and 3 both show a cap of an embodiment of the present invention. The cap 90 is sized to cover the channel 50 of the growing tray 10, and the cap 90 further comprises first groove 110 and second groove 112.

FIG. 4 shows the cap 90 of FIGS. 2 and 3 on the growing tray 10 of FIG. 1. In position, the first tongue means 60 fits within the first groove 110 and the second tongue means 62 fits within the second groove 112. This is one embodiment of a means for attaching the cap 90 to the growing tray 10, but other means can be used. In this embodiment with this tongue and groove system, there are various methods of attaching the cap 90 to the growing tray 10, for example, the first tongue means 60 can be placed within the first groove 110 at the first end 15 and the second tongue means 62 fit within the second groove 112 at the first end 15 and then the cap can be pressed and rolled out towards second end 17, such that the full length of the first and second tongue means fits within the full length of the first and second groove, respectively.

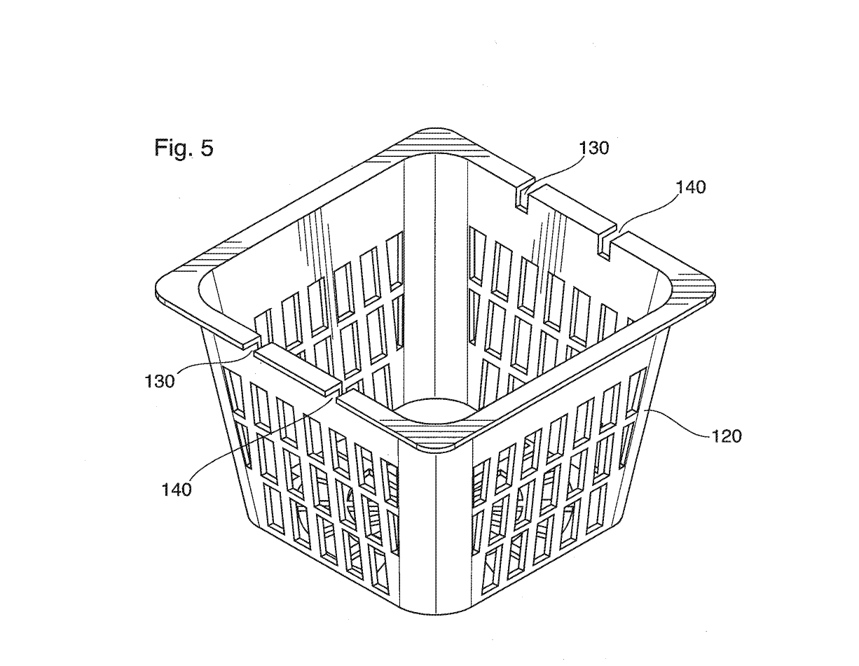

FIG. 5 shows a basket 120 of an embodiment of the present invention adapted with first slot 130 and second slot 140. A basket can be adapted to adjust to the parameters of a growing tray of any embodiment of the growing system of the present invention. The basket can be adapted to fit around any growing tray attachment means to a cap, and any indentation 70 in a growing tray 10. Depending on the hydroponic media used, the container for the media may vary or may not be even necessary, but when necessary, a basket 120 holds the hydroponic media and the plant in the media.

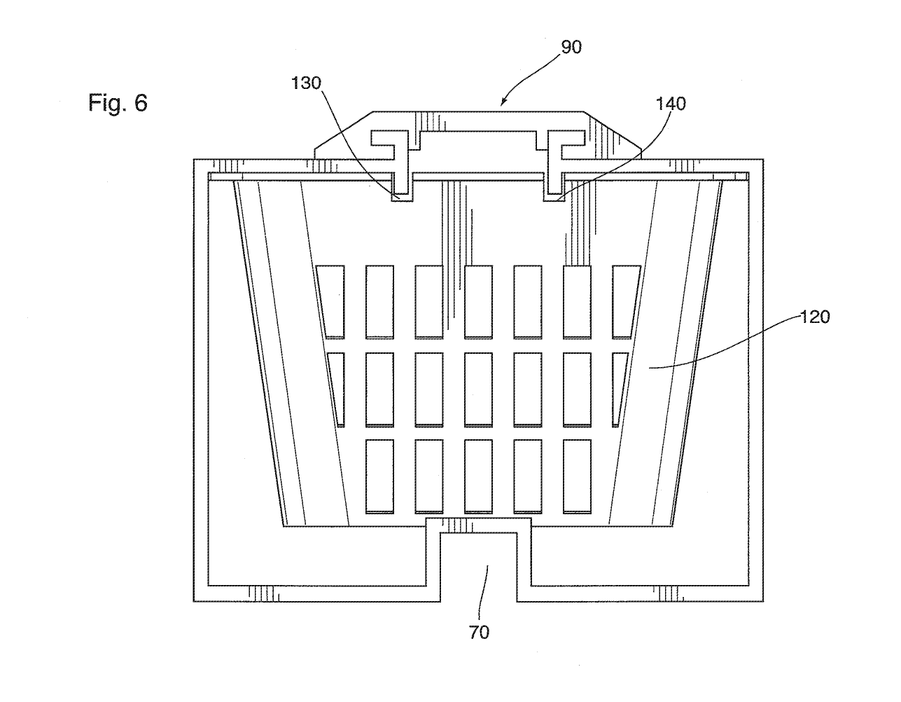

FIG. 6 shows the growing tray 10 and cap 90 of FIG. 4 with the basket 120 of FIG. 5. In this embodiment, the basket 120 is resting on the indentation 70 and the first and the basket 120 is adapted with a first slot 130 and a second slot 140 since in this embodiment the second tongue means 60 and 62 comprise protrusions below the first top 40 and second top 42. The basket 120 is used when the hydroponic media is loose and needs to be contained in a basket or is more manageable in a basket. The basket 120 can be sized to fit snugly within the growing tray 10. The basket 120 can rest on the bottom 20 or when the bottom additionally comprises an indentation 70 then the basket 120 can rest on the indentation.

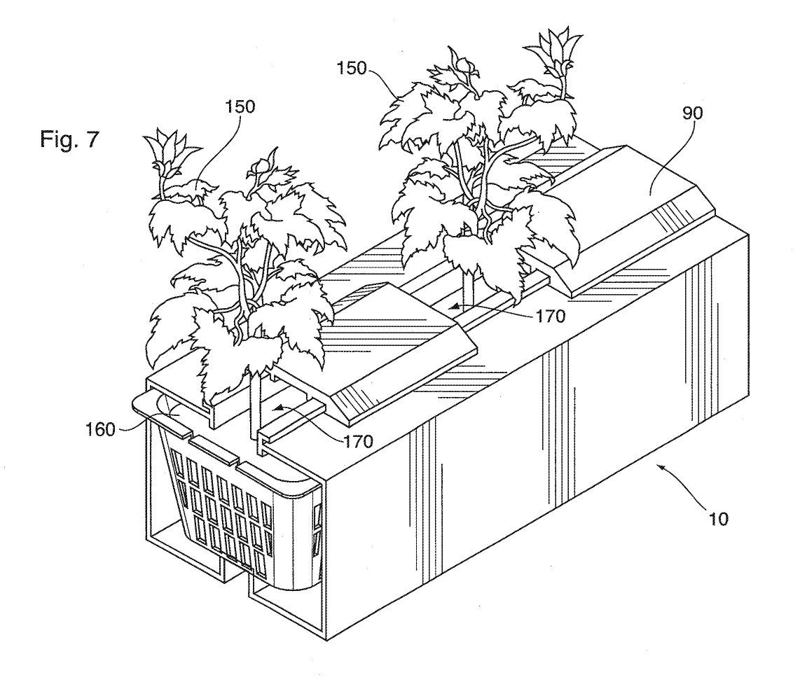

FIG. 7 shows the growing tray 10, cap 90 and basket 120 of FIG. 6 with plants 150 protruding from gaps 170 in the cap 90. The plants 150 are in growing cubes 160.

The growing cubes 160 comprise hydroponic media in which plants can grow. If the hydroponic media is a solid cube, then the growing cube comprises that media, but if the hydroponic media is loose, such as with gravel such as lava rocks, then the growing cube comprises the basket 120 with the loose hydroponic media in it.

In use, the growing cubes 160 can be rockwool or gravel (or other hydroponic media) with or without a container or basket 120 depending on the media. The growing cubes 160, with or without baskets 120, are slid into either the first end 15 or second end 17 of the growing tray 10. The growing cubes 160 are spaced apart if necessary for growth of the chosen plants 150. A cap 90 is attached to the growing tray 10 by fitting the first and second tongue means 60 and 62 into the first and second grooves 110 and 112, respectively.

In order for the plants 150 to grow, it is necessary to have gaps 170 in the cap 90 at the points at which the plants 150 are situated. These gaps 170 can be made by cutting the cap such that the cap is not contiguous, but only covers the portions between plants. Alternatively, these gaps can be merely holes through which the plant can fit through and can be made by punching out a hole in the cap, or slicing right through the cap with a hole-shape in about the middle for the plant to fit through. The material of the cap 90 is such that it can be cut, for example, by a punch, a knife, cutting shears, cutting pliers, box cutter or other cutting tool.

One method for determining where the gaps 170 should be located is to place the cap 90 alongside the channel 50 on either the first top 40 or second top 42 so that cap 90 can be cut adjacent to the points at which the plants 150 are situated, such that when the cap 90 is attached to the growing tray 10, the plants 150 protrude through the gaps 170. Another method is to measure the distance between the centres of growing cubes 160 and measure and cut the cap 90 segments accordingly.

Another method is to have the cap 90 precut in segments rather than long lengths. A further method is to have the cap 90 precut with holes and in use the growing cubes 160 have to be positioned in the tray such that the seedling or future plant will be under the holes when the cap is in place.

There is empty space between the growing cubes 160 in which roots from the plants 150 can expand into. The cap 90 covers these spaces and light is reduced or eliminated from reaching into these spaces.

In an embodiment of the invention in which the bottom 20 comprises an indentation 70, the growing cube 160 or basket 120 in the growing tray, rests on the indentation 70. Thus there is empty space on either side of the indentation 70 in which roots of the plants 150 can expand into.

Gravity is an issue encountered with any rotating hydroponic system. In particular growing cubes 160 with hydroponic media which is loose in a basket (as opposed to a solid block) can fall out when the growing cubes are upside down. The growing tray and cap system of the present invention has a channel 50 and cap 90 which reduces loose hydroponic media falling out when a growing cube is upside down.

The cap 90 in an embodiment of the invention is made of polyvinyl chloride (“PVC”). The material of the cap is ideally any material that is light resistant, flexible enough to attach to the growing tray, holds hydroponic media in, and can be cut at the locations at which plants will grow. The cap 90 can be pre-cut in segments or with holes when manufactured, or the cap can be manufactured as long pieces and cut afterwards as needed. The light resistant nature of the cap 90 reduces the light in the spaces between plants where roots can expand into.

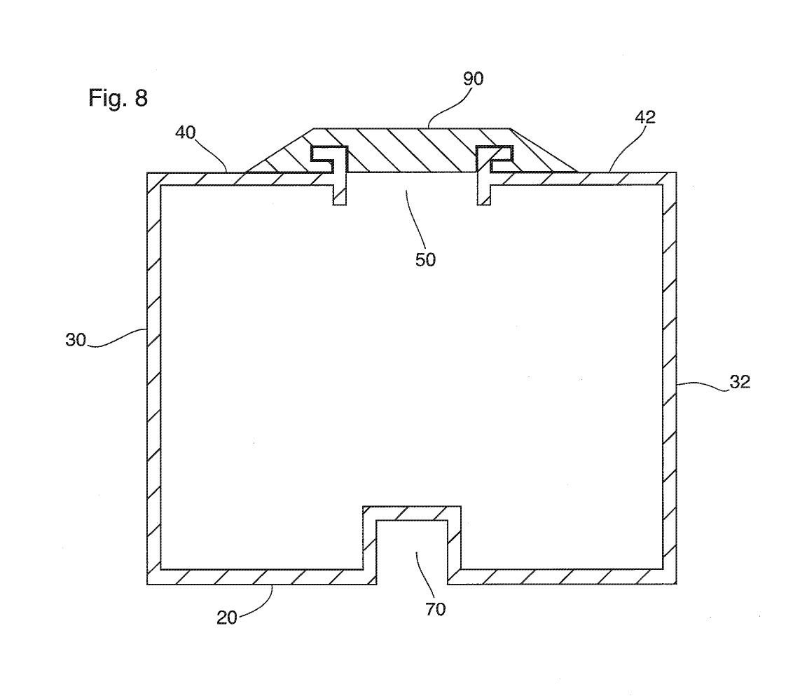

The cap 90 is attached to the growing tray in any manner that would allow for the cap to generally cover the spaces between the plants. FIG. 8 is a second embodiment of a cap 90 of a further embodiment of the invention, and various embodiments of the invention are possible. The cap 90 of the present invention can be used with a growing tray that does not comprise a channel 50, and in such a case the gaps 170 may be adapted so that the cap can provide more coverage since the growing tray is open at the top.

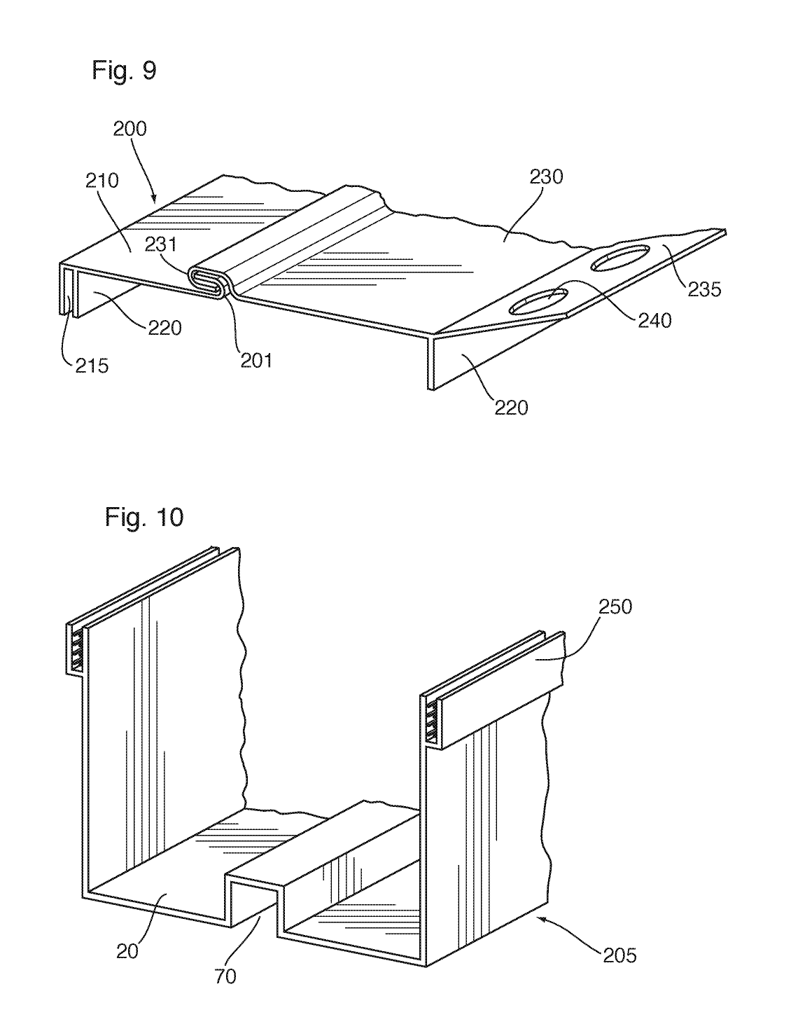

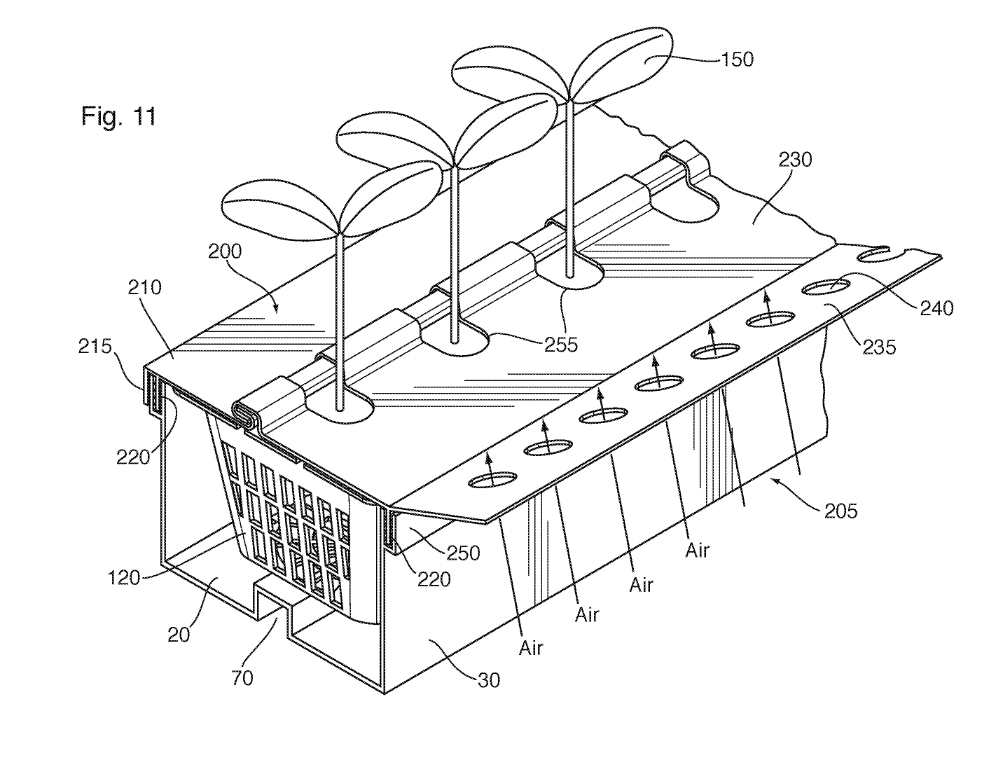

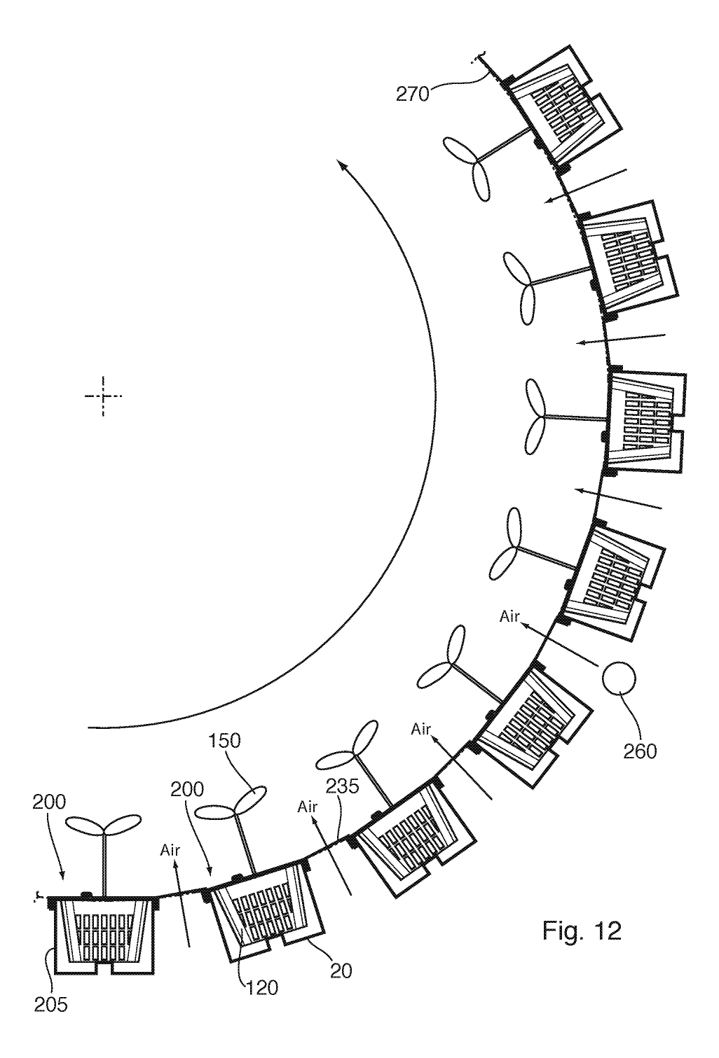

FIG. 9 is a third embodiment of a cap 200 with a flap 235. FIG. 10 is a third embodiment of an open trough tray 205 which can be used with cap 200 as is shown in FIGS. 11 and 12. The cap 200 keeps hydroponic media in the basket 120. The cap 200 can be cut to form grow holes 255 at the locations at which plants will grow through or be made with grow holes 255 pre-cut. When the cap 200 is used to cover the trays 205 which are placed in a rotating hydroponic garden, the flaps 235 cover the space between trays. The flap 235 sized so that when growing trays are placed adjacent to one another in a rotatable hydroponic garden the space between the trays is covered. The flap 235 may include air holes 240 so that any air or carbon dioxide can reach the plants or escape.

The cap 200 may be one piece or, as shown in FIG. 9, may be comprised of a first cap piece 210 and second cap piece 230. The tray covering portion of the cap 200 is contiguous with the flap 235. In this embodiment the first cap piece 210 is joined to the second cap piece 230 by a first hook 201 hooking together with a second hook 231. The cap 200 may additionally comprise grow holes 255 for plants to grow through or be comprised of a material for cutting grow holes in. In FIG. 9 the grow holes 255 are shown in the second cap piece 230 but they could also be in the first cap piece 200 or in a cap 200 of one piece rather than formed of two pieces.

FIG. 11 shows straight tongues 220 on the cap 200 providing securing means when inserted into the receiving means of the gripping channels 250 on the sides of the tray 205. A lip 215 aids in further securing the cap 200 to the tray 205 and allows the cap 200 to snap onto the tray 205. A lip 215 could be included on both sides of the cap 200. To remove the cap 200, flap 235 provides a handhold to pull the cap 200 off the tray 205, but the lip 215 can be pushed up as well.

FIG. 12 shows a wheel 270 of a rotating hydroponic garden in which multiple trays 205 with plants 150 are arranged which results in the cap 200 covering the trays and spaces between the trays. When the spaces between the trays are covered any leaves or plant debris would not fall between trays. Leaves falling between trays may become wet from nutrient/water and drip onto a centre light of a rotating hydroponic garden. In a rotating hydroponic garden with one or more perforated tubes 260 for delivering CO₂ or air, the CO₂ reaches the plants 150 through the air holes 240 in the flaps 235. From the above detailed description, the operation and construction of the invention should be apparent. While there are herein shown and described example embodiments of the invention, it is nevertheless understood that various changes may be made with respect thereto without departing from the principle and scope of the invention.

1. A cap for a plant growing tray for a rotatable hydroponic garden, said cap comprising a tray covering portion for covering the tray and a flap portion, wherein the tray covering portion is adapted to removably secure to the growing tray, and said flap is adapted so that when said growing plant trays covered with said caps are placed adjacent to one another in a rotatable hydroponic garden the space between the trays is covered by the flaps.

2-13. (canceled)

14. The cap of claim 1 in which the flap additionally comprises air holes.

15. The cap of claim 1 in which the tray covering portion additionally comprises grow holes for plants to grow through.

16. A plant growing tray and cap for a rotatable hydroponic garden,
said plant growing tray comprising a trough having a first end and a second end, at least one of the first end and the second end being open, a bottom, sides, and a top defining a channel exposing the interior of the trough, and said sides adapted with receiving means for removably securing the cap to the plant growing tray,
said cap comprising a tray covering portion and a flap portion, wherein the tray covering portion is adapted with securing means to removably secure the tray covering portion to the growing tray, and said flap is adapted so that when plant growing trays covered with said caps are placed adjacent to one another in a rotatable hydroponic garden the space between the trays is covered by the flaps.

17. The plant growing tray and cap of claim 16 in which the flap additionally comprises air holes.

18. The plant growing tray and cap of claim 16 in which the tray covering portion additionally comprises grow holes for plants to grow through.

19. The plant growing tray and cap of claim 16 in which the receiving means comprises gripping channels running along the sides of the plant growing tray and the securing means comprises straight tongues extending substantially perpendicularly on each side of the tray covering portion, wherein the cap is removably secured to the plant growing tray when the straight tongues are inserted into the gripping channels.

20. The securing means of claim 19 which additionally comprises at least one lip on the tray covering portion parallel to one or both straight tongues such that when the cap is removably secured to the plant growing tray the lip grips the outside of the gripping channel.

21. The plant growing tray and cap of claim 16 in which the growing tray additionally provides a space for roots of a plant to expand by providing an interior surface of the bottom comprising a raised portion having a substantially flat shelf for receiving a plant.
